(19) United States
(12) Patent Application Publication
(10) Pub. No.: US 2010/0240353 A1
(43) Pub. Date: Sep. 23, 2010

(54) REMOTE CONTROL SYSTEM AND FACILITY SIDE CONTROL APPARATUS AND CONTROL PROGRAM OF FACILITY APPARATUS AND CONTROL METHOD OF FACILITY APPARATUS

(75) Inventors: Yosuke Kaneko, Tokyo (JP); Hitoshi Kamasaka, Tokyo (JP); Shinji Kitagami, Tokyo (JP); Akihisa Yasuda, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Tokyo (JP)

(21) Appl. No.: 12/599,303

(22) PCT Filed: May 15, 2007
(86) PCT No.: PCT/JP2007/059976

§ 371 Date: Jan. 27, 2010

(51) Int. Cl. G05B 19/042; H04W 4/00

(52) U.S. Cl. 455/420; 700/7; 700/8; 700/17

(57) ABSTRACT

Disclosed is a wireless remote control system that provides a system for suppressing the communication fee. The server apparatus 100 calls the facility side control apparatus 200a via the public line 410. When the facility side control apparatus 200a detects the outgoing call received as an incoming call, it connects to the internet 420 and transmits a control command request 920 serving as a request to the server apparatus 100. The server apparatus 100 receives the control command request 920 serving as a request via the internet 420, and transmits the control command 930 serving as a reply to this request to the facility side control apparatus 200a via the internet 420. The facility side control apparatus 200a receives the control command 930 from the server apparatus 100, and instantly controls the facility apparatus 300a in accordance with the control command 930 received.

### FIELD OF THE INVENTION

The present invention relates to, for remotely controlling a facility apparatus, a remote control system, a facility side control apparatus, a control program of the facility apparatus and a control method of the facility apparatus.

### DESCRIPTION OF THE RELATED ART

The present invention belongs to the technical field for remotely controlling the facility device such as air conditioner or lighting, using the internet. The present invention relates to a method of establishing a communication session that uses a wireless terminal such as cellular phone or PHS™ (personal handy-phone system), as the communication of facility device side. Methods discussed in patent documents 1 and 2 are inventions that relate to a remote supervision of the facility device using the conventional wireless terminal. According to patent document 1, a remote management center and a facility device provided with a wireless terminal are connected through a public line, and a remote control is performed from the remote management center. In addition, the method discussed in patent document 2 uses a specific service of carrier, for example, Dopa™, for a network between the facility device provided with the wireless terminal and the remote management center. Further, conventionally, there is generally a method called a polling method. The polling method is the method that periodically accesses from the facility device to the remote management center, confirms the availability of a control command, and executes a control when the control command has arrived.

Normally, the wireless terminal cannot be accessed directly from outside via an IP (internet protocol) network. For this reason, in order to perform the remote control of the facility device by using the wireless terminal, there is a need for transmitting the control command to the wireless terminal by any one of the following methods, namely; using the public line as discussed in patent document 1; using the specific service of carrier as discussed in patent document 2; or implementing an outbound communication from the facility device to the remote management center as in the polling method.
Patent document 1: JP2001-274917A
Patent document 2: JP2001-339464A

### DISCLOSURE OF THE INVENTION

### Problems to be Solved by the Invention

The method of patent document 1 performs the remote control by connecting a communication between the facility device and the remote management center, using the public line. This method uses the public line so that there is a need to prepare a plurality of communication apparatuses (such as modem) in the remote management center when attempting to control a plurality of facility devices at the same time. For this reason, there is a problem of increasing cost of the remote management center as a size of the service gets large.

The method of patent document 2 performs the remote control by connecting a communication between the facility device and the remote management center, using the specific service of carrier. For this reason, there are problems that a wireless terminal is restricted to that usable in the remote management, and a service usage fee must be paid to the carrier.

In the polling method, the facility device periodically communicates with the remote management center, and an arrival of the control command is confirmed. For this reason, there are problems of a time lag occurring prior to the control as a result of setting a polling interval long, and incurring the communication fee even if the remote control is not being performed.

The present invention aims to implement the remote control using the wireless terminal such as cellular phone or PHS™, as the communication of the facility device side, without relying on a specific service of the carrier or a specific wireless terminal. Also, the present invention aims to control the plurality of facility devices at the same time, by using the IP network of the wireless terminal, without having to prepare the plurality of communication apparatuses at the remote management center. Further, the present invention aims to reduce a wasteful communication fee put on the facility device because the facility device performs the communication only when the operator actually wishes to perform the control.

### Means to Solve the Problems

A remote control system comprising a server apparatus that receives a control command request serving as a request requesting for a control command that instructs a control of a predetermined facility apparatus via a network and transmits the control command as a reply to the request via the network, and a facility side control apparatus that receives via the network the control command as a reply from the server apparatus by transmitting the control command request serving as a request to the server apparatus via the network while connecting to the facility apparatus, and instantly executes a control of the facility apparatus in accordance with the control command received;

wherein the server apparatus includes a server side outgoing call controlling unit that transmits an outgoing call to the facility side control apparatus via a first network and a server side communication server function unit that receives a request via a second network and transmits a reply to the request received via the second network;

wherein the facility side control apparatus includes a facility side incoming call receiving unit that receives the outgoing call of the server side outgoing call controlling unit from the first network, a facility side incoming call controlling unit that detects the outgoing call received by the facility side incoming call receiving unit as an incoming call, a facility side data communication unit capable of communication with the server side communication server function unit via the second network by connecting to the second network, and a facility side communication agent function unit that transmits a request to the server side communication server function unit using the facility side data communication unit, that receives from the server side communication server function unit a reply to the request using the facility side data communication unit and that executes a content indicated by the reply received;

wherein the server side outgoing call controlling unit transmits the outgoing call to the facility side control apparatus via a first network;

wherein the facility side incoming call receiving unit receives from the first network the outgoing call of the server side outgoing call controlling unit;

wherein the facility side incoming call controlling unit detects the outgoing call received by the facility side incoming call receiving unit as an incoming call;

wherein the facility side communication agent function unit transmits a request of the control command request to the server side communication server function unit via the second network using the facility side data communication unit when the facility side incoming call controlling unit detects an incoming call;

wherein the server side communication server function unit receives the request of the control command request from the facility side communication agent function unit via the second network, and transmits via the second network the control command as a reply to the request to the facility side communication agent function unit; and

wherein the facility side communication agent function unit receives the control command as a reply to request from the server side communication server function unit, via the second network using the facility side data communication unit and instantly controls the facility apparatus in accordance with the control command received.

The remote control system, wherein the facility side communication agent function unit instantly controls the facility apparatus in accordance with the control command received, and transmits an instant control result as a request, to the server side communication server function unit via the second network using the facility side data communication unit; wherein the server side communication server function unit receives the instant control result as a request via the second network from the facility side communication agent function unit.

The remote control system comprising the server side communication server function unit and the facility side communication agent function unit, for which the following operations are repeated once and more as one set: the server side communication server function unit transmits to the facility side communication agent function unit a new control command as a reply to the instant control result by taking an opportunity of receiving the instant control result as a request; and the facility side communication agent function unit receives from the server side communication server function unit using the facility side data communication unit the new control command as a reply, instantly controls the facility apparatus in accordance to the new control command received, and transmits the instant control result as a request to the server side communication server function unit using the facility side data communication unit,

wherein the server side communication server function unit, when ending the remote control of the facility apparatus, after receiving a last instant control result being a last request, transmits to the facility side communication agent function unit an end command instructing an end of the control to the facility apparatus as a reply to the last instant control result;

wherein the facility side communication agent function unit receives using the facility side data communication unit the end command as a reply, and stops transmission of the request to the server side communication server function unit when the end command is received.

The remote control system, further comprising a terminal apparatus that transmits the control command as a request to the server apparatus via the second network;

wherein the server side communication server function unit receives the control command as a request from the terminal apparatus via the second network;

wherein the server side outgoing call control unit transmits an outgoing call to the facility side control apparatus by taking an opportunity of receiving the control command from the terminal apparatus by the server side communication server function unit; and

wherein the server side communication server function unit transmits to the facility side communication agent function unit the control command received from the terminal apparatus as a reply to the control command request received from the facility side communication agent function unit.

The remote control system, wherein the facility side communication agent function unit instantly controls the facility apparatus in accordance with the control command received, and transmits the instant control result as a request, to the server side communication server function unit via the second network using the facility side data communication unit; and

wherein the server side communication server function unit receives from the facility side communication agent function unit the instant control result as a request via the second network, and transmits to the terminal apparatus the instant control result received as a reply to the request received from the terminal apparatus via the second network.

The remote control system comprising the terminal apparatus, the server side communication server function unit, and the facility side communication agent function unit, for which the following operations are repeated once and more as one set: the terminal apparatus transmits to the server side communication server function unit via the second network a new control command as a request by taking the opportunity of receiving the instant control result as a reply; the server side communication server function unit receives from the terminal apparatus via the second network the new control command, and transmits to the facility side communication agent function unit as a reply to the instant control result serving as a request received from the facility side communication agent function unit the new control command received; the facility side communication agent function unit receives from the server side communication server function unit using the facility side data communication unit the new control command as a reply, instantly controls the facility apparatus in accordance with the new control command received, and transmits to the server side communication server function unit using the facility side data communication unit an instant control result as a request; and the server side communication server function unit receives the instant control result as a request from the facility side communication agent function unit, and transmits to the terminal apparatus as a reply to the new control command serving as the request received from the terminal apparatus the instant control result received;

wherein the terminal apparatus, when ending the remote control of the facility apparatus, after receiving from the server side communication server function unit a last instant control result serving as a last reply, transmits to the server side communication server function unit via the second network an end command that instructs an end of the control to the facility side control apparatus as a request;

wherein the server side communication server function unit receives the end command as a request, and transmits the end command received to the facility side communication agent function unit as a reply to the instant control result serving as a request received last from the facility side communication agent function unit; and

wherein the facility side communication agent function unit receives using the facility side data communication unit the end command transmitted as a reply by the server side communication server function unit, and stops transmission of the request to the server side communication server function unit when the end command is received.

The remote control system, wherein the facility side communication agent function unit disconnects a communication with the server side communication server function unit using the facility side data communication unit in case a predetermined time has elapsed without receiving from the server side communication server function unit the new control command as a reply to the instant control result, after transmitting the instant control result as a request using the facility side data communication unit.

The remote control system, wherein the server side outgoing call function unit includes to the outgoing call an identification number that identifies a call origin being the server apparatus; and

wherein the facility side communication agent function unit transmits to the server side communication server function unit the control command request only when the identification number included to the outgoing call is an identification number of the server apparatus.

The remote control system comprising the server side communication server function unit and the facility side communication agent function unit, in which an HTTP (hyper text transfer protocol) protocol is used for a communication via the second network.

The remote control system comprising the server side communication server function unit, the facility side communication agent function unit, and the terminal apparatus, in which an HTTP (hyper text transfer protocol) protocol is used for a communication via the second network.

The remote control system, wherein the terminal apparatus uses a WWW (World Wide Web) browser, for a communication with the server side communication server function unit.

The facility apparatus control system, wherein the first network includes a public line.

The facility apparatus control system, wherein the first network is an IP (internet protocol) telephone network.

The facility apparatus control system, wherein the facility side incoming call receiving unit is implemented by any one of cellular phone or PHS™ (personal handy-phone system) terminal.

The facility apparatus control system, wherein the second network includes a packet network.

The facility apparatus control system, wherein the second network includes a data communication network.

A facility side control apparatus for receiving a control command that instructs a control of a facility apparatus via a network, and executing an instant control of the facility apparatus in accordance with the control command received, comprising:

a facility side incoming call receiving unit that receives, from a server apparatus for receiving a control command request requesting for the control command as a request via a second network while transmitting an outgoing call via a first network and for replying via the second network the control command as a reply to the control command request received, via the first network the outgoing call transmitted by the server apparatus;

a facility side incoming call controlling unit that detects the outgoing call received by the facility side incoming call receiving unit as an incoming call;

a facility side data communication unit that can communicate with the server apparatus via the second network by connecting to the second network; and

a facility side communication agent function unit that transmits to the server apparatus via the second network the control command request as a request using the facility side data communication unit when the facility side incoming call controlling unit detects the incoming call, that receives from the server apparatus via the second network using the facility side data communication unit the control command as a reply to the control command request, and that instantly controls the facility apparatus in accordance with the control command received.

A control program of a facility apparatus for receiving via a network a control command that instructs a control of a facility apparatus, and in accordance with the control command received, the facility side control apparatus, being a computer that executes an instant control of the facility apparatus, executes the followings:
(1) a process of receiving, from a server apparatus for receiving a control command request requesting for the control command as a request via a second network while transmitting an outgoing call via a first network and for replying via the second network the control command as a reply to the control command request received, via the first network the outgoing call transmitted by the server apparatus;
(2) a process of detecting the outgoing call received as an incoming call; and
(3) a process of transmitting to the server apparatus via the second network the control command request as a request by taking an opportunity of incoming call detection, receiving from the server apparatus via the second network the control command as a reply to the control command request, and instantly controlling the facility apparatus in accordance with the control command received.

A control method of a facility apparatus performed by a facility side control apparatus, for receiving via a network a control command that instructs a control of the facility apparatus, and executing an instant control of the facility apparatus in accordance with the control command received, comprising:

receiving, from a server apparatus for receiving a control command request requesting for the control command as a request via a second network while transmitting an outgoing call via a first network and for replying via the second network the control command as a reply to the control command request received, via the first network the outgoing call transmitted by the server apparatus, by a facility side incoming call receiving unit;

detecting the outgoing call received by the facility side incoming call receiving unit as an incoming call, by a facility side incoming call controlling unit; and

transmitting to the server apparatus via the second network the control command request as a request by taking an opportunity of incoming call detection by the facility side incoming call controlling unit, receiving from the server apparatus via the second network the control command as a reply to the control command request, and instantly controlling the facility apparatus in accordance with the control command received, by a facility side communication agent function unit.

### Effects of the Invention

According to the present invention, the communication fee of the remote control system is suppressed.

### DETAILED DESCRIPTION OF THE EMBODIMENTS

### First Embodiment

FIG. 1 illustrates a system outline of the remote management system 1000 (an example of the remote control system) according to the first embodiment. As shown in FIG. 1, the remote management system 1000 provides a server apparatus 100 and a facility side control apparatus 200a that instantly controls a facility apparatus 300a by receiving a control command 930 via the internet 420 (a second network) from the server apparatus 100. An outline of the remote control by the server apparatus 100 follows next.
(1) The server apparatus 100 transmits an outgoing call 910 to the facility side control apparatus 200a via a public line 410 (a first network).
(2) The facility side control apparatus 200a detects the outgoing call 910 as an incoming call.
(3) The facility side control apparatus 200a, when detecting the incoming call, connects to the internet 420 by wireless communication, and transmits to the server apparatus 100 a control command request 920 serving as a request, via the internet 420.
(4) The server apparatus 100 receives the control command request 920 serving as a request from the facility side control apparatus 200a, via the internet 420. The server apparatus 100, when receiving the control command request 920, transmits the control command 930 serving as a reply to this request to the facility side control apparatus 200a, via the internet 420.
(5) The facility side control apparatus 200a receives the control command 930 from the server apparatus 100 via the internet 420, and instantly controls the facility apparatus 300a in accordance with the control command 930 received.
(6) As described above, a characteristic of the remote management system 1000 lies in remotely controlling the facility apparatus 300a based on the request and the reply via the second network by taking an opportunity of the outgoing call via the first network.

FIG. 2 illustrates the external appearance of the server apparatus 100 according to the first embodiment. As shown in FIG. 2, the server apparatus 100 comprises hardware resources such as a system unit 830, a displaying apparatus 813 having a display screen as in CRT (cathode ray tube) or LCD (liquid crystal display), a keyboard 814, a mouse 815, a FDD 817, a compact disk drive (CDD) 818, and a printer 819. These are connected with cables or signal lines.

The system unit 830 is a computer. Also, as shown in FIG. 2, the system unit 830 is connected to the public line 410 and the internet 420. The facility side control apparatus 200a is connected to the public line 410 and the internet 420.

FIG. 3 illustrates an example of the hardware resources of the server apparatus 100 according to the first embodiment. Further, the facility side control apparatus 200a, the terminal apparatus 500a, and the like, as will be described later, are also computers, and their hardware configurations are the same as FIG. 3. Thus, the following explanation related to FIG. 3 can also be applied as it is to the facility side control apparatus 200a and the terminal apparatus 500a, which will be described later.

Referring to FIG. 3, the server apparatus 100 comprises a CPU 810 (may also be referred to as a central processing apparatus, a processing unit, an arithmetic unit, a microprocessor, a microcomputer, and a processor) for executing programs. The CPU 810 is connected to a ROM (read only memory) 811, a RAM (random access memory) 812, the displaying apparatus 813, a keyboard 814, a mouse 815, a first communication unit 816a, a second communication unit 816b, a FDD 817, the CDD 818, the printer 819, and a magnetic disk apparatus 820, via a bus 825, and controls these hardware devices. Instead of the magnetic disk apparatus 820, a storage apparatus such as an optical disk apparatus and a flash memory may also be used.

An example of volatile memory is the RAM 812. Examples of a non-volatile memory are storage medium such as the ROM 811, the FDD 817, the CDD 818, the magnetic disk apparatus 820, and the like. These are the examples of a storage apparatus or a storing unit or storage unit. Examples of an inputting unit or an inputting apparatus are the first communication unit 816a, the second communication unit 816b, the keyboard 814, the FDD 817, and the like. Also, examples of an outputting unit or an outputting apparatus are the first communication unit 816a, the second communication unit 816b, the displaying apparatus 813, the printer 819, and the like.

The first communication unit 816a is connected to the public line 410 (the first network) capable of making an outgoing call. The second communication unit 816b is connected to the internet 420 (the second network).

The magnetic disk apparatus 820 stores an operating system 821 (OS), a window system 822, programs 823, and files 824. The CPU 810, the operating system 821, and the window system 822 execute programs of the programs 823.

In the programs 823 the programs that execute functions described as “. . . unit” in the following description of the embodiments are stored. The CPU 810 reads and executes the programs.

The files 824, in the description of the following embodiments, store information described as “determined result of . . . ”, “calculated result of . . . ”, “extracted result of . . . ”, “generated result of . . . ” and “processed result of . . . ”, or data, signal value, variable value, parameter, or the like, are stored as each item of “. . . file” or “. . . database”. The “. . . file” or “. . . database” is stored on the storage medium such as a disk or a memory. The CPU 810 reads out the information, the data, the signal value, the variable value, or the parameter stored on the storage medium such as the disk or the memory, to a main memory or a cache memory, via a read and write circuit. These are used in CPU operations such as extract, search, refer, compare, compute, calculate, process, output, print, and display. During the CPU operations such as extract, search, refer, compare, compute, calculate, process, output, print and display, the information, the data, the signal value, the variable value, or the parameter is temporarily stored on the main memory, the cache memory, or a buffer memory.

In addition, in the description of the following embodiments, the data or the signal value is stored on the storage media such as a memory of the RAM 812, a flexible disk of the FDD 817, a compact disk of the CDD 818, a magnetic disk of the magnetic disk apparatus 820, as well as an optical disk, a mini disk, a DVD (digital versatile disk), or the like. Also, the bus 825, the signal line, the cable, and other transmission medium transmit on line the data or the signal.

Further, in the description of the following embodiments, those described as “. . . unit” may also mean “. . . circuit”, “. . . apparatus”, “. . . device”, and “. . . means”, or also maybe “. . . step”, “. . . procedure” and “. . . process”. That is, what is described as “. . . unit” may also be implemented on a firmware stored on the ROM 811. Alternatively, it may be implemented only on a software, only on a hardware such as element, device, substrate, wire, a combination of the software and hardware, or a combination with the firmware. The firmware or the software is stored on the storage media such as the magnetic disk, the flexible disk, the optical disk, the compact disk, the mini disk, the DVD, or the like, as programs. The CPU 810 reads and executes the programs. That is, the programs enable a computer to operate as “. . . unit” described below. Alternatively, the programs enable the computer to execute a procedure or method of the “. . . unit” described below.

Next, a configuration of the remote management system 1000 (the remote control system) of the first embodiment will be described with reference to FIG. 4. FIG. 4 is a configuration chart showing the remote management system 1000 of the first embodiment. The remote management system 1000 comprises a single remote management center 1, and a plurality of facility devices 2a to 2n. The remote management center 1 and the facility devices 2a to 2n are connected via the first network, the public line, and the second network, the internet or a mobile network.

An outline of operation is described with reference to FIG. 4.
(1) An outgoing call function unit 121 of the server apparatus 100 transmits an outgoing call to the facility side control apparatus 200a via the public line 410, the first network.
(2) An incoming call function unit 211a of the facility side control apparatus 200a receives an outgoing call from the public line 410 (a base station of the public line 410) as a wireless signal.
(3) An incoming call control function unit 231a detects the outgoing call received by the incoming call function unit 211a as an incoming call.
(4) A communication agent function unit 232a, when the incoming call control function unit 231a detects the incoming call, transmits a control command request serving as a request, to a server side communication server function unit 113, via a mobile network 430, by connecting with wireless communication to the mobile network 430 (a base station of the mobile network 430) using the data communication function 212a.
(5) The server side communication server function unit 113 receives the control command request serving as a request from the communication agent function unit 232a, via the mobile network 430. The server side communication server function unit 113, when receiving the control command request, transmits a control command serving as a reply to this request, to the communication agent function unit 232a, via the mobile network 430.
(6) The control command is received using the communication agent function unit 232a and a data communication function unit 212a via the mobile network 430, and the facility apparatus 300a is instantly controlled in accordance with the received control command.

(Remote Management Center 1)

The remote management center 1 comprises the server apparatus 100. The server apparatus 100 is configured with a remote management server 110 and a communication apparatus 120. An operator 11 performs a control of the facility devices 2a to 2n using the server apparatus 100.

(Remote Management Server 110)

The remote management server 110, for example, is a PC server, being an apparatus comprising the CPU, the memory, the HDD, and Ethernet™, and various communication I/F (interfaces) such as RS-232C and USB. A server function unit 111 executes server functions. The server function unit 111 comprises an outgoing call control function unit 112 (server side outgoing call controlling unit) and the server side communication server function unit 113. The outgoing call control function unit 112 controls the outgoing call function unit 121 of the communication apparatus 120. The server side communication server function unit 113 performs a communication with the communication agent function units of the facility devices 2a to 2n, via “the internet 420 or the mobile network 430” (the second network).

(Communication Apparatus 120)

The communication apparatus 120 is an apparatus such as a modem, comprising the outgoing call function unit 121. The outgoing call function unit 121 has a function that transmits an outgoing call via the public line 410, the function that a normal modem or the like possess. The remote management server 110 and the communication apparatus 120 are connected by an interface such as USE, RS-232C and PCMCIA. The remote management server 110 provides to the operator 11 an external interface for controlling the facility devices 2a to 2n.

(Facility Device 2)

All facility devices 2a to 2n has the same configuration so that the facility device 2a is described herein as an example. The facility device 2a is configured with the facility side control apparatus 200a and the facility apparatus 300a. Also, the facility side control apparatus 200a comprises the wireless terminal 210a and a control apparatus 220a.

The facility apparatus 300a is an apparatus targeted for a remote control, the examples of which includes the air conditioner, a refrigerating apparatus, the lighting, and various sensors. Also, the facility apparatus 300a, as long as it is a controllable apparatus, is intended to a wide ranging home appliances, but not particularly limited to a PC, a communication device, AV devices such as video and television, and a refrigerator and washing machine.

The control apparatus 220a is an apparatus that controls the facility apparatus 300a, having the CPU, the memory unit, the HDD, and the communication I/F that connects the facility device 300a and the wireless terminal 210a, and comprises an agent function unit 230a. The agent function unit 230a comprises the incoming call control function unit 231a and the communication agent function unit 232a. The incoming call control function unit 231a controls the incoming call function unit 211a of the wireless terminal 210a. The communication agent function unit 232a uses the data communication function unit 212a of the wireless terminal 210a to perform communication with the server side communication server function unit 113 of the remote management center 1, via the second network.

The wireless terminal 210a is a communication device such as cellular phone or PHS™, comprising the incoming call function unit 211a and the data communication function unit 212a. The data communication function unit 212a is a function that communicates using a packet communication or a data communication usable by a normal cellular phone (hereinafter denoted as the mobile network 430 altogether). Further, the packet communication is a per packet charged communication method, which is charged depending on an amount of communication, and the data communication is a communication time charged communication method, which is charged depending on a communication time. The incoming call function unit 211a is a function that receives an incoming call from the public line 410 and that a normal wireless terminal 210a possess. The facility device 300a and the control apparatus 220a are connected with an interface that depends on the facility apparatus 300a, such as Ethernet™, Lonworks™, RS232C, Bluetooth™, IrDa, or an I/F unique to the facility. The control apparatus 220a and the wireless terminal 210a are connected with an interface that the wireless terminal 210a corresponds, such as USB, PCMCIA, and compact flash™.

Further, in the first embodiment, as for the configuration of the facility device 2a, the facility apparatus 300a and the control apparatus 220a are regarded as different apparatus, however, these may also be configured as an integrated apparatus. In this configuration, it is configured that the agent function unit 230a operates in the facility device 300a, and the facility device 300a and the wireless terminal 210a are connected. Similarly, the facility device 300a, the control apparatus 220a, and the wireless terminal 210a can be integrated as one apparatus. In this case, it may be configured that the agent function unit 230a, the data communication function unit 212a, and the incoming call function unit 211a operate in the facility device 300a.

Further, in the first embodiment, it is configured by providing the communication apparatus 120 to the remote management center 1, and the outgoing call control function unit 112 controls the outgoing call function unit 121 to transmit an outgoing call via the public line. Alternatively, it may be configured that the outgoing call function unit 112 may transmit an outgoing call via an IP telephone network (one example of the public line). In this case, the communication apparatus 120 is not needed. The outgoing call control function unit 112 connects to a server of an IP telephone provider via the internet 420, and operates to transmit an outgoing call.

Next, an operation of the remote management system 1000 when executing the remote control to the facility device 2a will be described with reference to FIG. 5. Of course, the remote control to the other facility devices is also the same as the remote control to the facility device 2a.

(Regular Operation)

At first, the regular operation will be described. First of all, in step S11, the server side communication server function unit 113 waits for an arrival of the control command from the operator 11. Further, the server side communication server function unit 113 waits for an arrival of the request from the communication agent function unit 232a. Also, in step S12, on the wireless terminal 210a the incoming call function unit 211a is active, and it is in a receiving mode of the incoming call from the public line 410. Further, in step S13, the incoming call control function unit 231a monitors an incoming call to the wireless terminal 210a. Further, the incoming call control function unit 231a controls the wireless terminal 210a just like a normal modem, monitoring the incoming call.

(Operation of the Remote Control: the Server Apparatus 100 Side)

An operation of executing the remote control will be described with reference to FIG. 5. At first, in step S14, the operator 11 specifies a control command to the server side communication server function unit 113. Further, the control command includes a command code for controlling the facility device 300a and a facility device ID that fixedly identifies the facility device 2a. At this time, the server side communication server function unit 113 manages by associating the command code with the facility device ID at an internal buffer (not illustrated). Next, in step S15, the server side communication server function unit 113 specifies the facility device ID and calls the outgoing call control function unit 112. Based on this, in step S16, the outgoing call control function unit 112 searches a telephone number managed by associating with the facility device ID, and calls the outgoing call function unit 121 by specifying the telephone number. After that, in step S17, the outgoing call function unit 121 calls the specific telephone number. Then, the outgoing call function unit 121 is disconnected immediately after the call.

(Facility Device 2a Side)

Based on the operation described so far, the incoming call function unit 211a of the facility device 2a targeted for control receives the incoming call. Next, in step S18, the incoming call control function unit 231a detects the incoming call. Further, in step S19, the incoming call control function unit 231a notifies to the communication agent function unit 232a that the incoming call is detected. Based on this, in step S110, the communication agent function unit 232a operates to establish the communication of the mobile network 430 (the second network), and transmits a “request of the control command request” to the server side communication server function unit 113. In this case, the communication agent function unit 232a possesses an address of the server apparatus 100 in advance, therefore, it can transmit the request of the control command request to the server apparatus 100. Also, the communication agent function unit 232a transmits by including its own address to the request of the control command request. Based on this, the server apparatus 100 will know the address of the facility side control apparatus 200a. Therefore, the communication between the server side communication server function unit 113 and the communication agent function unit 232a via the mobile network 430, the second network, is established. After the communication between the server side communication server function unit 113 and the communication agent function unit 232a has been established, as shown in FIG. 4, the communication between the server side communication server function unit 113 and the communication agent function unit 232a is performed via the mobile network 430 (the second network). Further, the request of the control command request includes an information that can specify an own facility device ID.

Based on the operation that has been described so far, the server side communication server function unit 113 receives the “request of the control command request” from the communication agent function unit 232a. The server side communication server function 113 receives the “request of the control command request”, then in step S111, activates a thread for executing the later processing of the communication agent function unit 232a that requested this request. Next, in step S112, a facility device ID of the facility device 2a that has sent a request is specified based on the received request. Based on the specified facility device ID, in step S14, the control command stored in the internal buffer is specified. Further, in step S113, the server side communication server function unit 113 transmits the control command specified in step S112 as a reply to the request of the communication agent function unit 232a received in step S110.

(Facility Device 2a Side)

According to the operation described so far, the communication agent function unit 232a receives the control command to the facility device 300a. Based on this, in step S114, the communication agent function unit 232a refers to the received control command and controls the facility device 300a.

In the first embodiment, the facility side control apparatus 200a has been described as an apparatus. However, the facility side control apparatus 200a can be regarded as a facility apparatus control program executed by a computer as a process, by taking the operation of each configuration element of the facility side control apparatus 200a as the process.

Further, the incoming call control function unit 231a of the first embodiment operates to instantly notify to the communication agent function unit 232a when the incoming call has been detected, however, it may be operated to notify to the communication agent function unit 232a only when receiving an incoming call from a specific partner. That is, the outgoing call made by the outgoing call control function unit 112 includes a telephone number that identifies a call origin (the identification number). The communication agent function unit 232a may transmit the control command request only when the telephone number is a predetermined number.

Further, in the first embodiment, it may be operated by using an HTTP (hyper text transfer protocol) as a communication protocol between the server side communication server function unit 113 and the communication agent function unit 232a.

Further, in the first embodiment, when the wireless terminal 210a performs the communication via the mobile network 430, it is possible to communicate at any one of the packet communication or the data communication, however, it may be configured to set to operate with any one of the methods.

According to the remote management system 1000 described as per above, the wireless terminal 210a of the facility device 2a operates only based on the basic function of the wireless terminals, that is, the communication that uses the public line 410 and the communication that uses the mobile network 430. Therefore, its implementation is possible without having to make a specialized setup for the communication device or the specific service of the carrier.

Also, according to the remote management system 1000 described as per above, it operates to use the mobile network 430 in transmitting and receiving the control command between the server side communication server function unit 113 and the communication agent function unit 232a, therefore, it is possible to control a plurality of the facility devices all at the same time with a single communication apparatus 120 of the remote management center 1 because the public line 410 is not occupied during the transmission and reception of the control command.

Also, according to the remote management system 1000 as described per above, since it operates so that the facility device 2a acquires the control command by communicating with the remote management center 1 at a timing of the remote management center 1 performing the control. Its implementation is possible by charging a communication fee only by an actual amount of performing the remote control, without incurring the communication charge to an uncontrolled communication device at all.

Also, according to the remote management system 1000 described as per above, since it operates so that the facility device 2a acquires the control command by communicating with the remote management center 1 at a timing of the remote management center 1 performing the control. Its implementation is possible without putting a load on the remote management center 1 at all when the facility device 2a is not performing a control.

Also, according to the remote management system 1000 described as per above, it is possible to operate the communication agent function unit 232a only when an incoming call detected at the incoming call control function unit 231a is a specific caller. For this reason, the communication agent function unit 232a can be operated only when instructed by the remote management center 1. It is possible to prevent the wasteful communication fee being incurred by the facility device accessing to the remote management center 1 with a nuisance phone call or a wrong phone call.

Also, according to the remote management system 1000 described as per above, it is possible to implement the remote control by using the cellular phone or PHS™ terminal, therefore, a cost involved in wiring construction is suppressed, compared with a case of using the wired network.

Also, according to the remote management system 1000 described above, since the remote control is readily implemented by using the cellular phone or PHS™ terminal so that the wired network is not required, therefore, the wiring construction is not required when temporarily requiring to perform the remote control under such instances as a facility device failure or an initial introduction.

### Second Embodiment

Next, the remote management system 1000 of the second embodiment will be described with reference to FIG. 6. The second embodiment describes the case in which the facility side control apparatus replies a control result to the server apparatus 100. FIG. 6 showing the second embodiment further adds the step S115 onwards to FIG. 5 of the first embodiment. The explanation of its configuration is omitted being the same as the first embodiment.

In the above-mentioned first embodiment, the remote management center 1 calls the facility device when implementing the remote control, and the facility device (facility side control apparatus) when receiving an incoming call has transmitted a request of the control command request to the remote management center 1. Then, the facility device executes the control command transmitted as a reply from the remote management center 1, and the facility device 300a is controlled. The second embodiment describes the case in which the communication agent function unit 232a transmits a result of controlling the facility device 300a (instant control result) to the remote management center 1.

Similar to the case of the first embodiment, an example of controlling the facility device 2a will be described. The operation of steps S11 to S114 of FIG. 6 is the same as that of FIG. 5.

After the communication agent function unit 232a executes the control of the facility device 2a in step S114, it transmits a request of the control result to the server side communication server function unit 113 via the mobile network 430, by using the data communication function unit 212a, in step S115. Based on this operation, the server side communication server function unit 113 receives the request of the control result of the communication agent function unit 232a. At this time, the server side communication server function unit 113 activates a thread that executes the later processing of the communication agent function unit 232a that requested the request. After that, in step S116, the server side communication server function unit 113 returns the control result to the operator 11. In the end, in step S117, the server side communication server function unit 113 transmits a “control end command” as a reply to the control result serving as a request received from the communication agent function unit 232a in step S115. Based on this, the communication agent function unit 232a stops the process.

Further, the incoming call control function unit 231a of the second embodiment operates to instantly notify to the communication agent function unit 232a when the call is detected. However, it may operate to notify to the communication agent function unit 232a only when the incoming call is received from a specific partner.

Further, in the second embodiment, it may operate by using an HTTP protocol as the communication protocol between the server side communication server function unit 113 and the communication agent function unit 232a.

Further, in the second embodiment, when the wireless terminal 210a performs the communication via the mobile network 430, it is possible to communicate at any one of the packet communication method or the data communication method, however, it may be configured to set to operate at any one of the methods.

According to the remote management system 1000 of the second embodiment described as per above, it operates to return a result of the remote control implemented at the facility device to the remote management center 1. Therefore, the operator 11 can instantly refer to the result of the remote control implemented at the facility device.

Also, according to the remote management system 1000 of the second embodiment described as per above, as the communication of the communication agent function unit 232a via the mobile network 430, any one of the packet network or the data communication network is usable. For this reason, the data communication charged by the communication time is used to exchange large amounts of data of control commands and control results, without taking time in controlling the facility device 2. The packet communication charged by the communication amount is used to exchange small amounts of data of control commands and control results, taking much time in controlling the control device. A separate usage depending on their purposes is possible. Hence, a wasteful communication amount can be reduced.

The remote management system 1000 of the second embodiment described as per above provides all the same effects as those described in the first embodiment.

### Third Embodiment

The remote management system 1000 of the third embodiment will be described next by using FIG. 7. The third embodiment is the case for transmitting a plurality of control commands from the server side communication server function unit 113 to the communication agent function unit 232a, via the mobile network 430. FIG. 7 showing the third embodiment further adds step S118 and onwards to FIG. 6 of the second embodiment.

The above-mentioned first and second embodiments are preferred for the case of executing a control by transmitting a single control command from the remote management center 1 to the facility device when executing the remote control. The third embodiment is preferred for the case of executing a multiple number of controls from the remote management center 1 to the facility device.

FIG. 7 is a sequence drawing when the remote management system 1000 of the third embodiment executes the remote control to the facility device 2a. The operation is described by using FIG. 7. The description of operation of S11 to S116 in FIG. 7 is omitted being the same as that of FIG. 6. Further, at a point-in-time of finishing the step S116, the server side communication server function unit 113 maintains communication upon receiving a request from the communication agent function unit 232a in step S115.

In step S116, after the server side communication server function unit 113 returns the control result to the operator 11 (for example, a terminal apparatus that the operator 11 uses), in step S118, the operator 11 once again specifies a new control command to the same facility device 2a. Next, in step S119, the server side communication server function unit 113 transmits the new control command specified in step S118 as a reply of the control result serving as the received request in step S115. Further, in step S120, the communication agent function unit 232a controls the facility device 300a by referring to the new control command received. After that, the communication agent function unit 232a receives the control command as a reply while transmitting the request of the control result, and repeats once and more a procedure of steps S115, S116, S118, S119 and S120, executing a control of the facility device in accordance with the received control command. In this way, a multiple number of remote controls is executed.

In case that the operator 11 is ending the remote control to the facility device 2a, in steps S121 and S122, after the control result has been notified to the operator 11, in step S123, the operator 11 specifies the control end command. Next, in step S124, the server side communication server function unit 113 transmits the control end command specified in step S123 as a reply to the control result serving as the request received in step S121. The communication agent function unit 232a that received the control end command operates not to control the facility apparatus 300a, and not to transmit a request of the control result.

Further, in the third embodiment, the server side communication server function unit 113 operates to maintain communication upon receiving the request of the control result from the communication agent function unit 232a, however, after the maintained state has elapsed over a fixed time period, the server side communication server function unit 113 may operate to automatically disconnect the communication with the communication agent function unit 232a. Also, the communication agent function unit 232a may disconnect the communication with the server side communication server function unit 113 when a specified time has elapsed during a period of time starting from transmitting the request of the control result to the server side communication server function unit 113 until receiving the new control command as a reply to the request.

Further, the incoming call control function unit 231a of the third embodiment operates to instantly notify to the communication agent function unit 232a when the incoming call is detected. However, it may operate to notify to the communication agent function unit 232a only when the incoming call is received from a specific partner.

Further, in the third embodiment, it may operate to use an HTTP protocol as the communication protocol between the server side communication server function unit 113 and the communication agent function unit 232a.

Further, in the third embodiment, when the wireless terminal 210a performs the communication via the mobile network 430, it is possible to communicate at any one of the packet communication or the data communication, however, it may be configured to set to operate at any one of the method.

According to the remote management system 1000 of the third embodiment described above, it is operated to notify an arrival of the control command to the facility device by using the public line 410 only at a control starting time, in case that the operator 11 consecutively executes the multiple number of remote controls. Therefore, the remote controls after the second time onwards may be operated at a high speed than the remote control of the first time.

According to the remote management system 1000 of the third embodiment described as per above, it is operated to notify an arrival of the control command to the facility device by using the public line 410 only at a control starting time, in case that the operator 11 consecutively executes the multiple number of remote controls. Since the public line 410 need not be used for every execution of the control, an usage frequency of the public line 410 is decreased.

As described in the remote management system 1000 of the third embodiments described as per above, it is operated to automatically disconnect in case that the communication between the communication agent function unit 232a and the server side communication server function unit 113 is not performed for more than a fixed period. The operation can be automatically disconnected when the operator 11 forgets to send the control end command, and the wasteful communication fee is decreased.

Moreover, according to the remote management system 1000 of the third embodiment described as per above, the communication via the mobile network 430 of the communication agent function unit 232a may use any one of the packet network or the data communication network. For this reason, the data communication charged by the communication time is used to exchange the large amounts of the data of the control commands and the control results in a short time, on the other hand, the packet communication charged by the communication amount is used to exchange the small amounts of the data of the control commands and the control results in a long time. A separate usage depending on their purposes is possible. Thus, the wasteful communication amount can be reduced.

Moreover, the remote management system 1000 of the third embodiment described above provides all the same effects as those described in the second embodiment.

### Fourth Embodiment

Next, the remote management system 1000 of the fourth embodiment will be described with reference to FIGS. 8 and 9. The fourth embodiment corresponds to the first embodiment. According to the fourth embodiment, the operator does not send a control command from the remote management center 1, but it transmits a control command to the server apparatus 100 via the mobile network 430 or the internet 420 from the terminal apparatus of the operator, by connecting the terminal apparatus of the operator to the internet 420 and the mobile network 430 both serving as the second network. Then, when the server side communication server function unit 113 receives the control command from the terminal apparatus of the operator via the internet 420, it calls the facility side control apparatus 200a by taking an opportunity of the control command reception. The server side communication server function unit 113 transmits the control command received from the terminal apparatus, as the control command to the facility side control apparatus 200a, to the communication agent function unit 232a. FIG. 9, which will be described later, further adds steps S22 and S23 to FIG. 5 of the first embodiment.

The remote management systems 1000 of the above-mentioned first to third embodiments preferably operate when the operator is residing at the remote management center 1. The remote management system 1000 of the fourth embodiment preferably operates when the operator is away from the remote management center 1.

FIG. 8 is a configuration chart showing the remote management system 1000 of the fourth embodiment. The remote management system 1000 is configured with a single remote management center 1, a plurality of facility devices, and a plurality of terminal apparatuses 500a to 500n, via a network. The configuration of the remote management center 1 and the facility device is the same as FIG. 4.

As the operators 600a to 600n execute a similar operation, the operator 600a and the terminal apparatus 500a will be described herein. The operator 600a, in order to control the facility apparatus 300a, operates the terminal apparatus 500a. The terminal apparatus 500a is implemented in a form of desktop PC, note-type DC, PDA™, cellular phone, PHS™, or the like. It is the apparatus loading a CPU, a memory unit, a HDD, and Ethernet™, and providing a client function unit 510a. The client function unit 510a comprises a communication client function unit 511a. The communication client function unit 511a uses “the mobile network 430 and the internet 420” being the second network, to communicate with the server side communication server function unit 113 of the remote management center 1.

Next, an operation of the remote management system 1000 for the fourth embodiment when executing the remote control to the facility device 2a will be described with reference to the sequence chart of FIG. 9.

(Regular Operation)

At first, the regular operation will be described. To begin with, in step S21, at a regular time, the server side communication server function unit 113 waits for an arrival of a request from the communication client function unit 511a. Also, the server side communication server function unit 113 waits for an arrival of the request from the communication agent function unit 232a. Further, the operation of steps S12 and S13 is the same as the operation of FIG. 5.

(Operation of Executing Control)

Next, the operation of executing control will be described. At first, in step S22, the operator 600a specifies the control command to the communication client function unit 511a. Further, the control command comprises information that includes a command code for controlling the facility apparatus 300a and a facility device ID that fixedly identifies the facility device 2a. Next, in step S23, the communication client function unit 511a transmits a request of the control command to the server side communication server function unit 113. At this time, the server side communication server function unit 113 associates the command code with the facility device ID, and stores it to the inner buffer. After that, executing the process of S15 to S114 remotely controls the facility device 2a. Further, the operation of steps S15 to S114 is the same as the operation of FIG. 5.

Further, in the fourth embodiment, the communication client function unit 511a may be implemented at a WWW (World Wide Web) browser.

The incoming call control function unit 231a of the fourth embodiment operates to instantly notify to the communication agent function unit 232a when the incoming call is detected. However, it may operate to notify to the communication agent function unit 232a only when the incoming call is received from a specific partner.

Further, in the fourth embodiment, it may be operated by using the HTTP protocol as a protocol, for a communication between the server side communication server function unit 113 and the communication agent function unit 232a, and a communication between the server side communication server function unit 113 and the communication client function unit 511a.

Further, in the fourth embodiment, when the wireless terminal 210a performs the communication via the mobile network 430, it is possible to communicate at any one of the packet communication or the data communication, however, it may be configured to set to operate at any one of the method.

According to the remote management system 1000 of the fourth embodiment described as per above, a remote operator transmits the control command, and the server apparatus 100 of the remote management center 1 that received this control command controls the facility device. Therefore, the remote operator, such as a faraway maintainer or a device maker who resides at remote, can control the facility device.

Also, according to the remote management system 1000 of the fourth embodiment described as per above, since the communication client function unit 511a can be implemented on WWW, the remote control can be readily performed as long as it is an environment in which the operator can access the WWW.

Also, according to the remote management system 1000 of the fourth embodiment described as per above provides all the same effects as those described in the first embodiment.

### Fifth Embodiment

Next, the remote management system 1000 of the fifth embodiment will be described with reference to FIG. 10. The fifth embodiment corresponds to the second embodiment. FIG. 10, which will be described later, further added the operator and the operation of the communication client function unit 511a to FIG. 6 of the second embodiment.

The above-mentioned fourth embodiment has shown the configuration of controlling the facility device by the operator transmitting the control command to the remote management center 1 who resides at a location away from the remote management center 1. The fifth embodiment, which will be described below, is the case in which the remote management center 1 transmits a result of controlling the facility device 300a to the operator 600a.

The fifth embodiment will be described with reference to FIG. 10. Further, an operation of S21 to S23 is the same as the operation shown in FIG. 9. An operation of S12 to S117 is the same as the operation shown in FIG. 6 (except for step S24).

In step S23, when the server side communication server function unit 113 receives a request of the control command, in step S24, it activates a thread for executing the later processing to the communication client function unit 511a that requested the request. After that, based on the operation of S15 to S115, the server side communication server function unit 113 receives the request of the control result. Further, the control result includes a result of control to the facility device 2a and an information that specifies the executed control command. Based on this, the server side communication server function unit 113 hands over the control result to the thread motivated in step S24. Next, in step S25, the server side communication server function unit 113 sets and transmits a control result to a reply of the request of the communication client function unit 511a received in step S23. In the end, in step S26, the communication client function unit 511a notifies the control result to the operator 600a.

Further, the incoming call control function unit 231a of the fifth embodiment operates to instantly notify to the communication agent function unit 232a when the incoming call is detected. However, it may operate to notify to the communication agent function unit 232a only when the incoming call is received from a specific partner.

Further, in the fifth embodiment, it may operate by using an HTTP protocol, as a communication protocol between the server side communication server function unit 113 and the communication agent function unit 232a, and between the server side communication server function unit 113 and the communication client function unit 511a.

Further, in the fifth embodiment, when the wireless terminal 210a performs the communication via the mobile network 430, it is possible to communicate at any one of the packet communication or the data communication, however, it may be configured to set to operate at any one of the method.

According to the remote management system 1000 of the fifth embodiment, the operator transmits a control command from remote, and the remote management center 1 that received the control command operates to return a controlled result of the facility device to the operator while operating to control the facility device. For this reason, the result of the remote control implemented with the facility device by the operator who resides at remote, such as faraway maintainer or remote device maker, can be referred instantly.

According to the remote management system 1000 of the fifth embodiment described as per above, the communication via the mobile network 430 of the communication agent function unit 232a can use anyone of the packet network or the data communication network. For this reason, the data communication charged by the communication time is used to exchange the large amounts of the data of the control commands and the control results without taking too much time in controlling the facility device 2a, and the packet communication charged by the communication amount is used to exchange the small amounts of the data of the control commands and the control results taking much time in controlling the control device. The separate usage depending on their purposes is possible. The wasteful communication amount can be reduced.

Moreover, the remote management system 1000 of the fifth embodiment described as per above provides all the same effects as those described in the fourth embodiment.

### Sixth Embodiment

Next, the remote management system 1000 of the sixth embodiment will be described with reference to FIG. 11. The sixth embodiment corresponds to the third embodiment. FIG. 11, which will be described later, further added the operator 600a and the operation of the communication client function unit 511a to FIG. 7 of the third embodiment.

The above-mentioned fourth and fifth embodiments are preferable in case that a remote operator is executing a single control command to a facility device, during the remote control execution. The sixth embodiment is preferred in case that the operator is executing the control a plurality of times to the facility device.

The sixth embodiment will be described with reference to FIG. 11. Further, in FIG. 11, steps S21 to S26 and steps S12 to S15 are the same as the operation in FIG. 10, therefore, the explanation are omitted. Further, at a point-in-time of ending in step S26, the server side communication server function unit 113 maintains the communication upon receipt of the request from the communication agent function unit 232a in step S115.

In step S26, after the communication client function unit 511a returns the control result to the operator 600a, in step S27, the operator 600a once again specifies a new control command to the same facility device 2a. Next, in step S28, the communication client function unit 511a transmits a request of the new control command specified in step S27 to the server side communication server function unit 113. At this time, the server side communication server function unit 113 activates a thread for executing the later processing to the communication client function unit 511a that requested the request, in the same manner as the step S24. Next, in step S119, a new control command specified in S28 is transmitted as a reply of the control result serving as a request received in step S115. Further, in step S120, the communication agent function unit 232a controls the facility apparatus 300a by referring to the new control command received. After that, the communication agent function unit 232a transmits a request of the control result, receives the control command as a reply, and executes the control. The remote control is executed a plurality of times by repeating a procedure of S115, S25, S26, S27, S28, S119 and S120 once and more.

In case that the user 600a ends the remote control to the facility device 2a, in steps S121, S29 and S210, after notifying the control result to the operator 600a, in step S211, the operator 600a specifies the control end command. Based on this, in step S212, the communication client function unit 511a transmits a request of the control end command to the server side communication server function unit 113. Further, in step S124, the server side communication server function unit 113 transmits the control end command specified in step S212 as a reply to the request of the communication agent function unit 232a received in step S121. The communication agent function unit 232a that received the control end command operates to not to control the facility apparatus 300a, and not to transmit the request of the control result.

Further, in the sixth embodiment, the operator 600a and the facility device 2a are described as a set of 1:1, alternatively, a plurality of operators may control a single facility device 2a at the same time. As described above, the server side communication server function unit 113 operates to manage communications with the operators and the facility device by managing with an independent thread. For this reason, a queue is prepared to the server side communication server function unit 113, a queuing of the control commands is performed when a plurality of the communication by the operators is received all at the same time, and operates to transmit to the facility device as a control command to the facility device, in an order of arrival.

Further, in the sixth embodiment, the server side communication server function unit 113 operates to maintain the communication upon receipt of a request of the control result from the communication agent function unit 232a. However, after the maintained state has elapsed for more than a predetermined time, the server side communication server function unit 113 may operate to automatically disconnect the communication with the communication agent function unit 232a.

Further, the incoming call control function unit 231a of the sixth embodiment operates to instantly notify to the communication agent function unit 232a when the incoming call is detected. However, it may operate to notify to the communication agent function unit 232a only when the incoming call is received from a specific partner.

Further, in the sixth embodiment, it may operate to use an HTTP protocol as a communication protocol for the communication between the server side communication server function unit 113 and the communication client function unit 511a, and between the server side communication server function unit 113 and the communication agent function unit 232a.

Further, in the sixth embodiment, when the wireless terminal 210a performs the communication via the mobile network 430, it is possible to communicate at any one of the packet communication method or the data communication method, however, it may be configured to set to operate with any one of the methods.

The remote management system 1000 of the sixth embodiment as described above, in case that the operator consecutively executes the remote control a plurality of times, it operates to notify the arrival of the control command to the facility device using the public line 410 only at the control starting time. Therefore, the remote control from the second time onward can be operated at a higher speed than the remote control of the first time.

According to the remote management system 1000 of the sixth embodiment described above, it is possible to receive requests from a plurality of operators all at the same time by queuing, and it is possible to perform the remote control to the facility device in the order of arrival. For this reason, in case of consecutively executing the remote control of a plurality of operators, it operates to notify an arrival of the control command to the facility device by using the public line 410 only during a first time control of a first operator. Therefore, it becomes possible to operate a later remote control at a higher speed than the first time control of the first operator.

Also, according to the remote management system 1000 of the sixth embodiment described as per above, it operates to notify an arrival of the control command to the facility device by using the public line 410 only at a point-in-time of starting the control of consecutively executing the remote control a plurality of times by the operator that there is no longer a need to use the public line 410 for every execution of the control. For this reason, a usage frequency of the public line 410 can be decreased.

Moreover, according to the remote management system 1000 of the sixth embodiment described as per above, it operates to automatically disconnect the communication between the communication agent function unit 232a and the server side communication server function unit 113 in case that the communication is not performed for more than a predetermined time interval. For this reason, the automatic disconnection is possible in the event that the operator forgets to send the control end command, and the wasteful communication fee can be decreased.

Also, according to the remote management system 1000 of the sixth embodiment described above, either one of the packet network and the data communication network is usable as a communication of the communication agent function unit 232a using the mobile network 430. For this reason, the data communication charged by the communication time is used to exchange the large amounts of the data of the control commands and the control results in a short time, on the other hand, the packet communication charged by the amount of communication is used to exchange the small amounts of the data of the control commands and the control results in a long time. A separate usage depending on their purpose is possible. Thus, a wasteful communication amount can be reduced.

Also, according to the remote management system 1000 of the sixth embodiment described as per above, it can provide all the same effects as those described in the fifth embodiment.

According to the foregoing embodiments, in the remote management system performing a remote control or a remote supervision of the facility device, the remote management system that operates as follows has been described. It is configured with the remote management center that provides the outgoing call function and the communication server function, and the facility device that provides the incoming call function receiving an incoming call from the public line and the communication agent function. The communication server function and the communication agent function are connected via the network. When executing the remote control from the remote management center to the facility device, the outgoing call function transmits an outgoing call to the facility device and the incoming call function detects the outgoing call as the incoming call. Upon detection of the incoming call, the communication agent function transmits a request of the control command request to the communication server function. Upon receipt of the request, the communication server function transmits the control command as a reply of the request. Upon receipt of the reply, the communication agent function executes the control command.

In the foregoing embodiments, the remote management system that operates as follows has been described. The communication agent function transmits the control result of the control command as a request to the communication server function during execution ending of the control command for the facility device. Then, the communication server function receives it.

According to the foregoing embodiments, in the remote management system performing a remote control or a remote supervision of the facility device, the remote management system that operates as follows has been described. It is configured with the remote management center that provides the outgoing call function and the communication server function, and the facility device that provides the incoming call function receiving an incoming call from the public line and the communication agent function. The communication server function and the communication agent function are connected via the network. When executing the remote control from the remote management center to the facility device, the outgoing call function transmits the outgoing call to the facility device and the incoming call function detects the outgoing call as the incoming call. Upon detection of the incoming call, the communication agent function transmits the request of the control command request to the communication server function. Upon receipt of the request, the communication server function transmits the control command as a reply of the request. Upon receipt of the reply, the communication agent function executes the control command. After implementing the operation of transmitting the result to the communication server function as a request, the communication server function transmits a new control command as a reply to the request during the reception of the request. Upon receipt of the reply, the communication agent function executes the control command, and executes an arbitrary number of times the operation of transmitting to the communication server function the control result of the control command. When ending the remote control, the communication server function transmits the control end command as a reply of the request upon the receipt of the control result. The communication agent function does not execute the control upon receipt of the reply, and does not transmit the request to the communication server function.

According to the foregoing embodiments, in the remote management system performing a remote control or a remote supervision of the facility device, the remote management system that operates as follows has been described. It is configured with the remote management center that provides the outgoing call function and the communication server function, the facility device that provides the incoming call function receiving an incoming call from the public line, and the communication agent function and a control device providing the communication client function. The communication server function and the communication agent function and the communication client function are connected via the network. When the control device executes the remote control to the facility device, the communication client function transmits a request of the control command to the communication server function. Upon receipt of the request, the outgoing call function transmits the outgoing call to the facility device and the incoming call function detects the outgoing call as an incoming call. Upon detection of the incoming call, the communication agent function transmits a request of the control command request to the communication server function. Upon receipt of the request, the communication server function transmits the control command received from the communication client function as a reply to the request. Upon receipt of the reply, the communication agent function executes the control command.

In the foregoing embodiments, the remote management system that operates as follows has been described when ending execution of the control command for the facility device. The communication agent function transmits the control result of the control command as a request to the communication server function. Upon receipt of the request, the communication server function transmits the request of the control command received from the communication client function the control result as a reply.

According to the foregoing embodiments, in the remote management system performing a remote control or a remote supervision of the facility device, the remote management system that operates as follows has been described. It is configured with the remote management center that provides the outgoing call function and the communication server function, the facility device that provides the incoming call function receiving an incoming call from the public line and the communication agent function, and a control device providing the communication client function. The communication server function and the communication agent function and the communication client function are connected via the network. When the control device executes the remote control to the facility device, the communication client function transmits a request of the control command to the communication server function. Upon receipt of the request, the outgoing call function transmits the outgoing call to the facility device and the incoming call function detects the outgoing call as an incoming call. Upon detection of the incoming call, the communication agent function transmits a request of the control command request to the communication server function. Upon receipt of the request, the communication server function transmits the control command received from the communication client function as a reply to the request. Upon receipt of the reply, the communication agent function executes the control command, and transmits the control result as a request to the communication server function. Upon receiving the request, after the communication server function operates to transmit the control result as a reply to the request of the control command received from the communication client function, the communication client function transmits a request of the new control command to the communication server function. Upon receipt of the request, the communication server function transmits the control command of the request as a reply of the request of the control result received from the communication agent function. Upon receipt of the reply, the communication agent function executes the control command, and transmits the control result to the control command as a request to the communication server function. Upon reception of the request, the communication server function executes an arbitrary number of operations of transmitting the control result as a reply of the request of the control command received from the communication client function. When ending the remote control, the communication client function transmits a request of the control end command to the communication server function. Upon receipt of the request, the communication server function transmits the control end command as a reply of the request of the control result received from the communication agent function. Upon receipt of the reply, the communication agent function does not execute the control, and does not transmit the request to the communication server function.

In the foregoing embodiments, the remote management system that operates as follows has been described. It operates to disconnect the communication between the communication agent function and the communication server function when a specific time elapses starting from transmitting a request of the control result to the communication server function until receiving a new control command as a reply of the request at the communication agent function.

In the foregoing embodiments, the remote management system that operates as follows has been described. It operates so that the communication agent function transmits a request of the control command request to the communication server function only when the incoming call detected by the incoming call function is from a caller at a specific number.

The foregoing embodiments describe the remote management system that operates by using the HTTP protocol for the communications between the communication server function, the communication agent function, and the communication client function.

The above embodiments describe the remote management system in which the communication client function is serving as the WWW browser.

The foregoing embodiments describe the remote management system in which the outgoing call function calls by using the public line.

The foregoing embodiments describe the remote management system in which the outgoing call function transmits the outgoing call by using the IP telephone network.

The foregoing embodiments describe the remote management system that uses the cellular phone for the incoming call function of the facility device.

The foregoing embodiments describe the remote management system that uses the PHS™ for the incoming call function of the facility device.

The foregoing embodiments describe the remote management system that uses the packet network for a communication of the communication agent function.

The foregoing embodiments describe the remote management system that uses the data communication network for a communication of the communication agent function.

### BRIEF DESCRIPTION OF THE DRAWINGS

FIG. 1 is a drawing that describes an outline of remote management system 1000 according to a first embodiment.

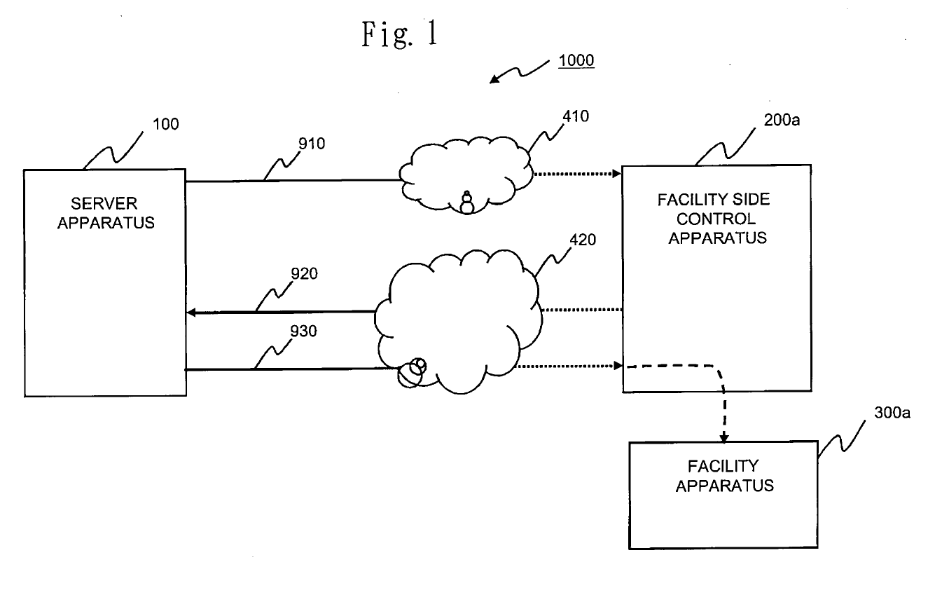

FIG. 2 is a drawing illustrating an external appearance of a server apparatus according to the first embodiment.

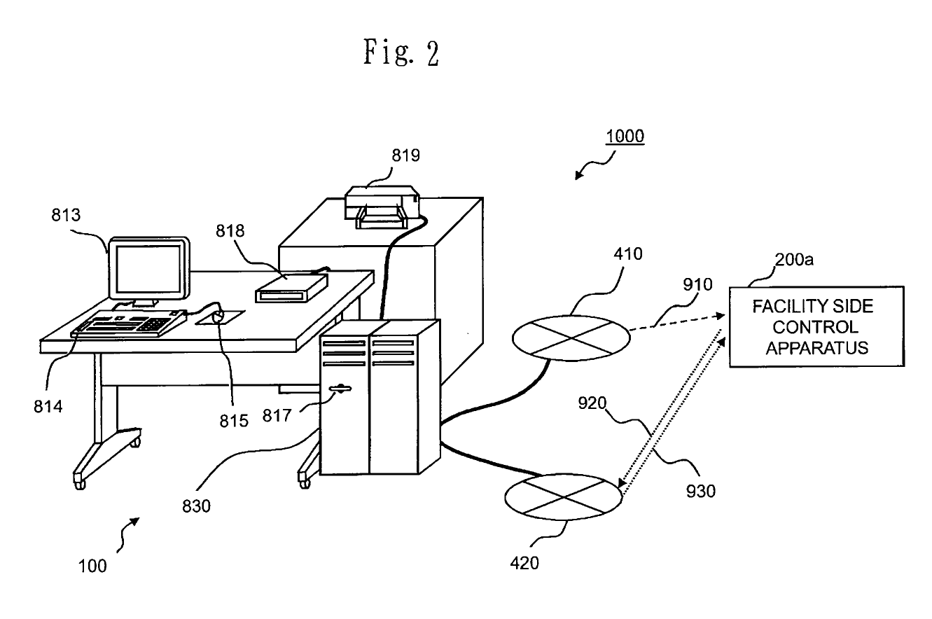

FIG. 3 is a hardware configuration of the server apparatus, a facility side control apparatus, and the like according to the first embodiment.

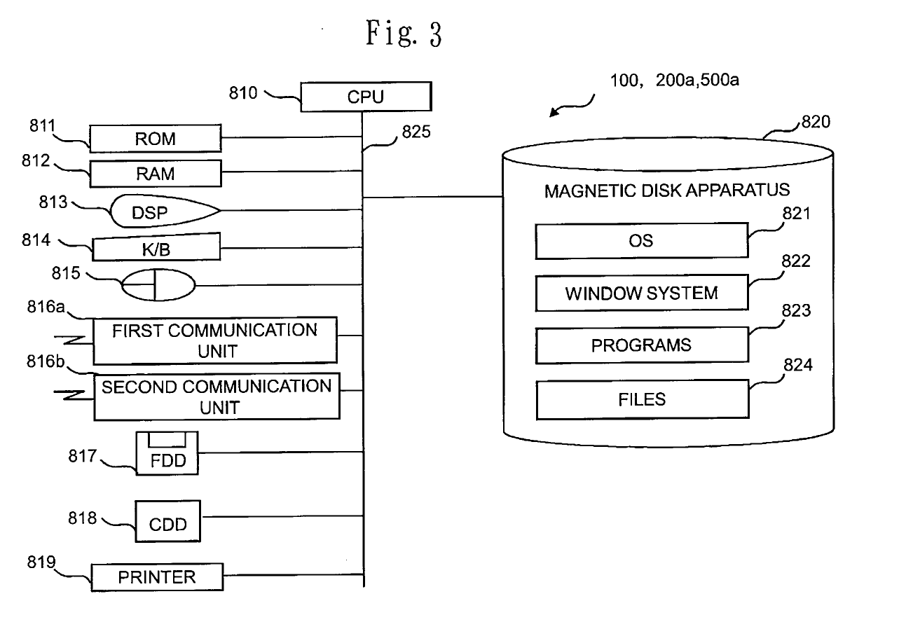

FIG. 4 is a system configuration chart of the remote management system 1000 according to the first embodiment.

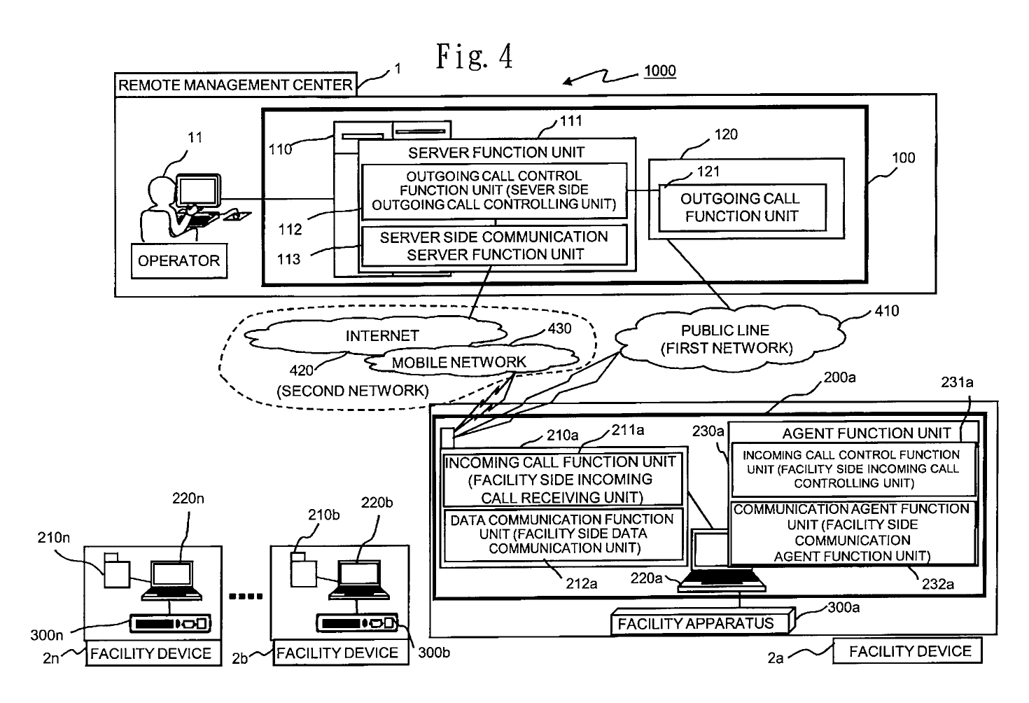

FIG. 5 is a flow chart for an operation of the remote management system 1000 according to the first embodiment.

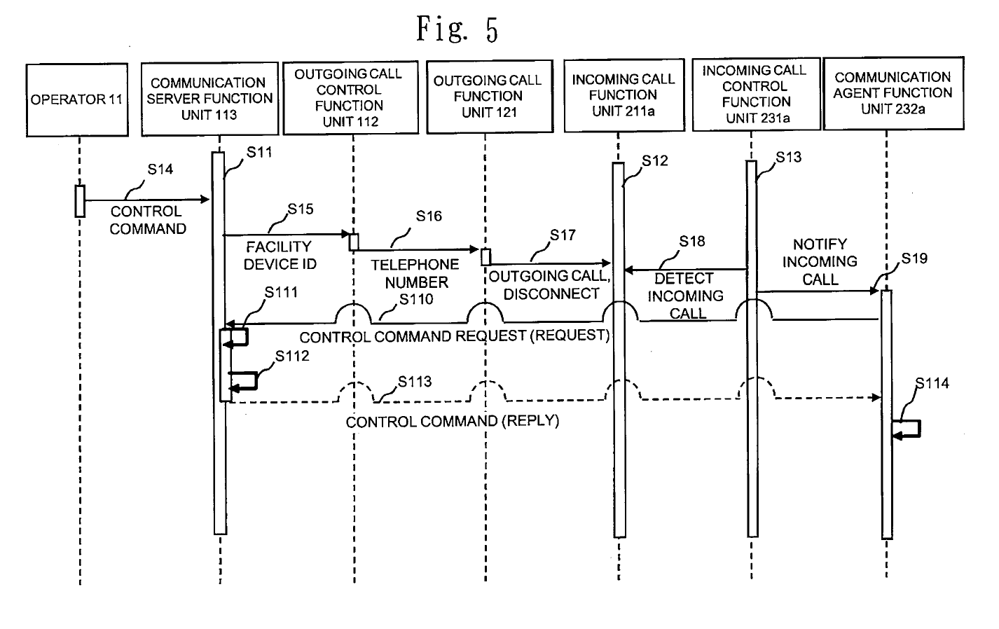

FIG. 6 is a flow chart for an operation of the remote management system 1000 according to a second embodiment.

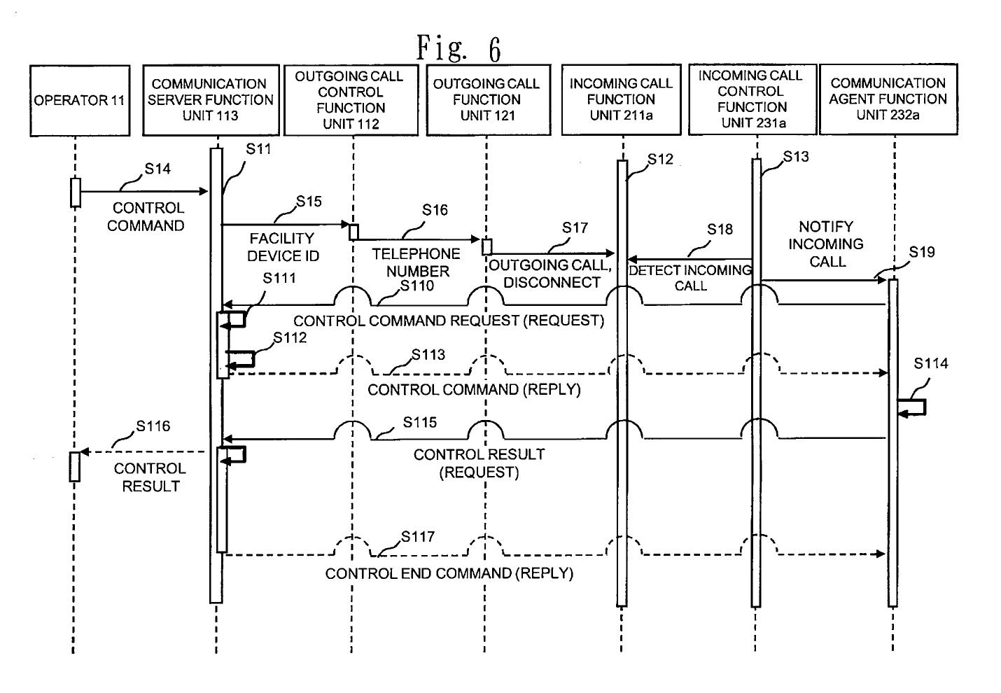

FIG. 7 is a flow chart for an operation of the remote management system 1000 according to a third embodiment.

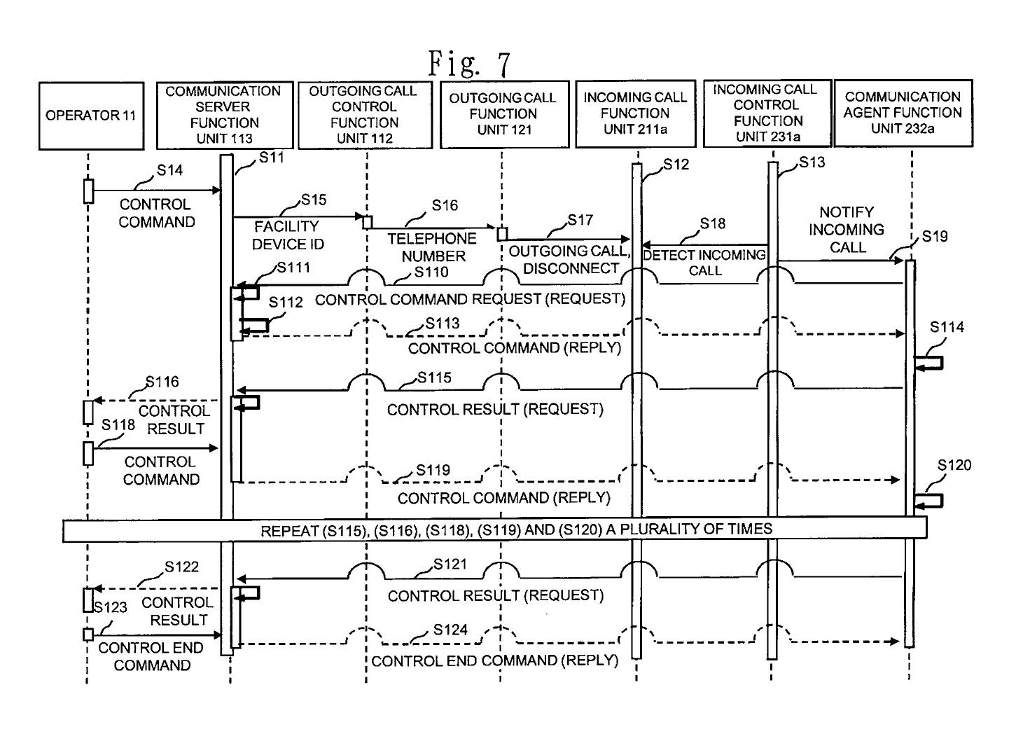

FIG. 8 is a system configuration chart of the remote management system 1000 according to a fourth embodiment.

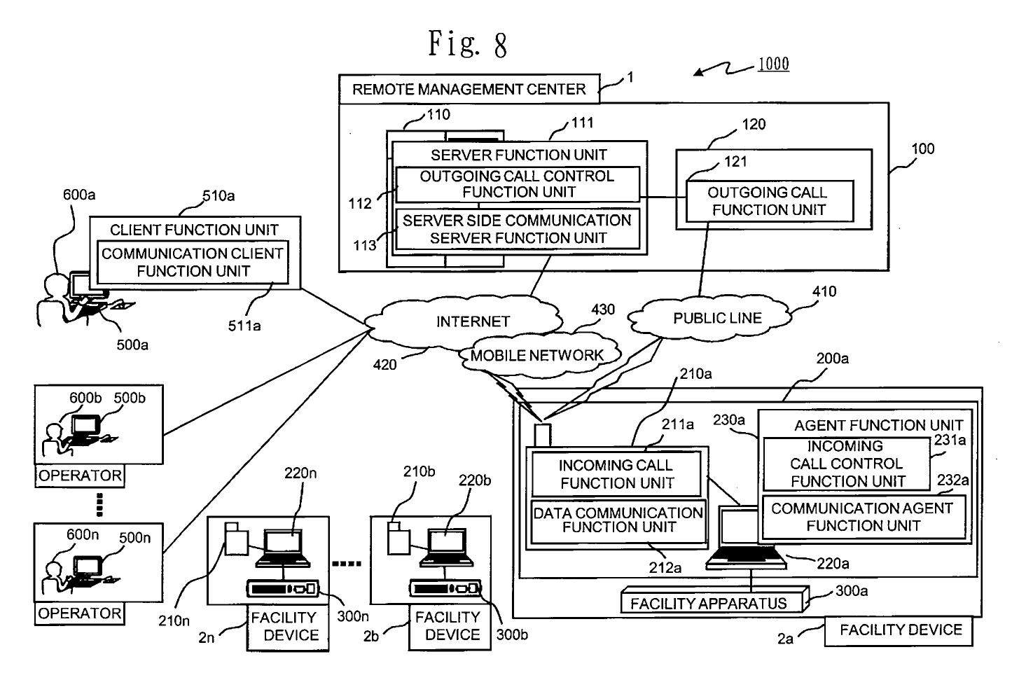

FIG. 9 is a flow chart for an operation of the remote management system 1000 according to the fourth embodiment.

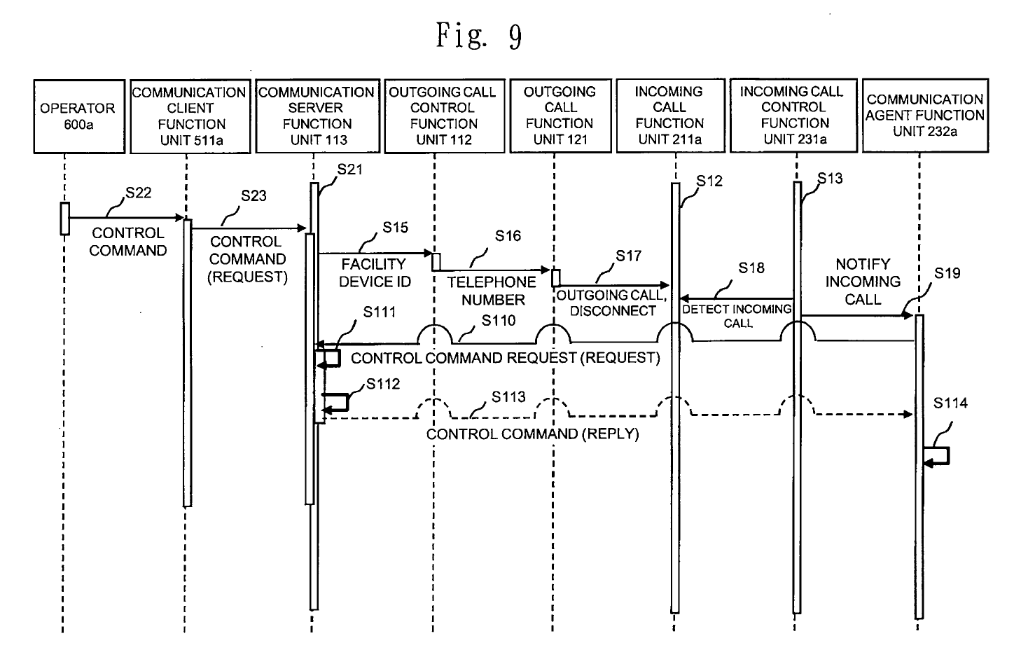

FIG. 10 is a flow chart for an operation of the remote management system 1000 according to the fifth embodiment.

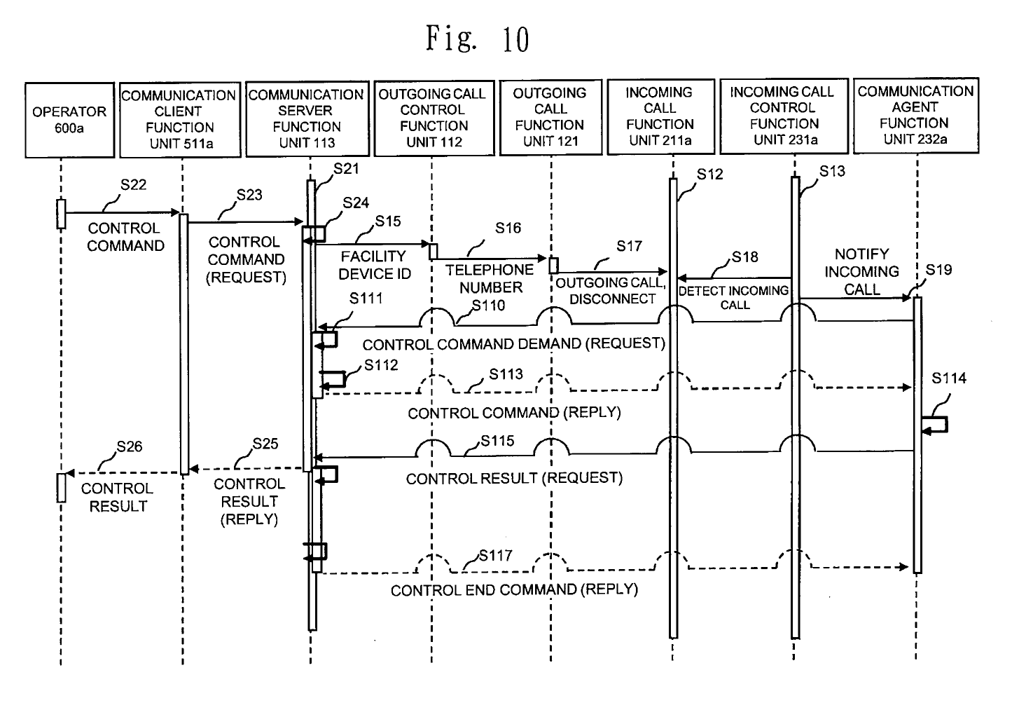

FIG. 11 is a flow chart for an operation of the remote management system 1000 according to the sixth embodiment.

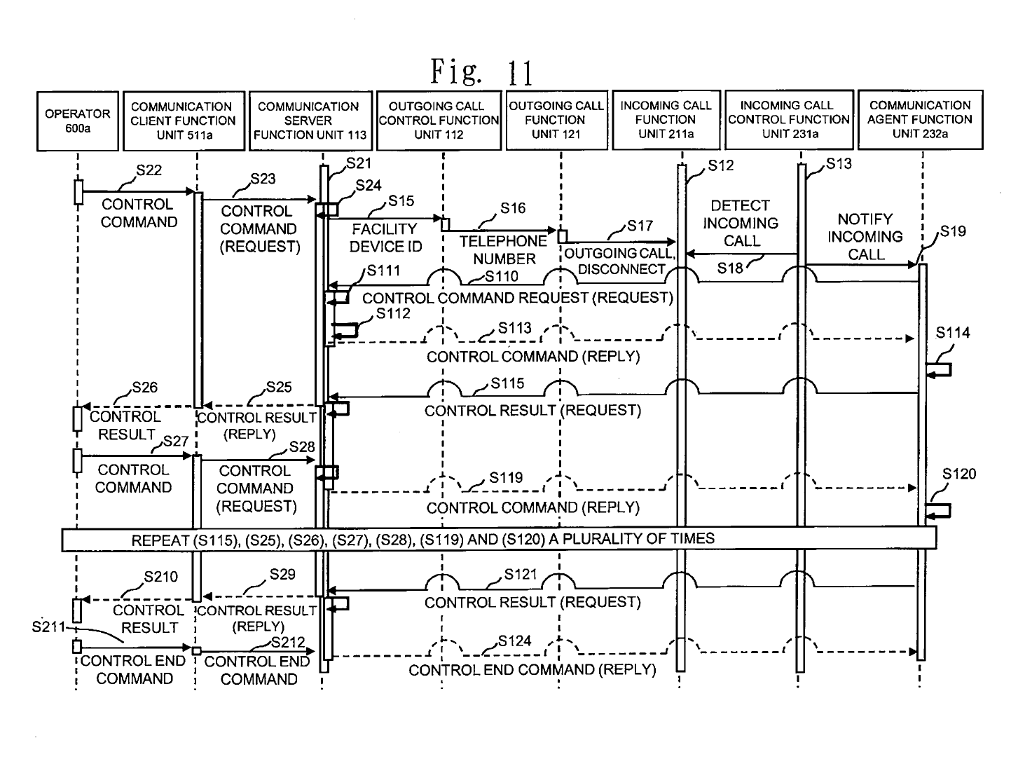

### REFERENCE SIGNS LIST

Remote management center 1; operator 11; server apparatus 100; remote management server 110; server function unit 111; outgoing call control function unit 112; server side communication server function unit 113; communication apparatus 120; outgoing call function unit 121; facility devices 2a, 2b, 2n; facility side control apparatus 200a; wireless terminals 210a, 210b, 210n; incoming call function unit 211a; data communication function unit 212a; control apparatuses 220a, 220b and 220n; agent function unit 230a; incoming call control function unit 231a; communication agent function unit 232a; facility apparatuses 300a, 300b and 300n; public line 410; internet 420; mobile network 430; terminal apparatuses 500a, 500b and 500n, client function unit 510a; communication client function unit 511a, operators 600a, 600b and 600n; CPU 810; ROM 811; RAM 812; display apparatus 813; K/B 814; mouse 815; first communication unit 816a; second communication unit 816b; FDD 817; CDD 818; printer 819; magnetic disk apparatus 820; OS 821; window system 822; programs 823; files 824; bus 825; system unit 830; outgoing call 910; control command request 920; control command 930; remote management system 1000

1. A remote control system comprising a server apparatus that receives a control command request serving as a request requesting for a control command that instructs a control of a predetermined facility apparatus via a network and transmits the control command as a reply to the request via the network, and a facility side control apparatus that receives via the network the control command as a reply from the server apparatus by transmitting the control command request serving as a request to the server apparatus via the network while connecting to the facility apparatus, and instantly executes a control of the facility apparatus in accordance with the control command received;
wherein the server apparatus includes a server side outgoing call controlling unit that transmits an outgoing call to the facility side control apparatus via a first network and a server side communication server function unit that receives a request via a second network and transmits a reply to the request received via the second network;
wherein the facility side control apparatus includes a facility side incoming call receiving unit that receives the outgoing call of the server side outgoing call controlling unit from the first network, a facility side incoming call controlling unit that detects the outgoing call received by the facility side incoming call receiving unit as an incoming call, a facility side data communication unit capable of communication with the server side communication server function unit via the second network by connecting to the second network, and a facility side communication agent function unit that transmits a request to the server side communication server function unit using the facility side data communication unit, that receives from the server side communication server function unit a reply to the request using the facility side data communication unit and that executes a content indicated by the reply received;
wherein the server side outgoing call controlling unit transmits the outgoing call to the facility side control apparatus via a first network;
wherein the facility side incoming call receiving unit receives from the first network the outgoing call of the server side outgoing call controlling unit;
wherein the facility side incoming call controlling unit detects the outgoing call received by the facility side incoming call receiving unit as an incoming call;
wherein the facility side communication agent function unit transmits a request of the control command request to the server side communication server function unit via the second network using the facility side data communication unit when the facility side incoming call controlling unit detects an incoming call;
wherein the server side communication server function unit receives the request of the control command request from the facility side communication agent function unit via the second network, and transmits via the second network the control command as a reply to the request to the facility side communication agent function unit; and
wherein the facility side communication agent function unit receives the control command as a reply to request from the server side communication server function unit, via the second network using the facility side data communication unit and instantly controls the facility apparatus in accordance with the control command received.

2. The remote control system according to claim 1, wherein the facility side communication agent function unit instantly controls the facility apparatus in accordance with the control command received, and transmits an instant control result as a request, to the server side communication server function unit via the second network using the facility side data communication unit; wherein the server side communication server function unit receives the instant control result as a request via the second network from the facility side communication agent function unit.

3. The remote control system according to claim 2 comprising the server side communication server function unit and the facility side communication agent function unit, for which the following operations are repeated once and more as one set: the server side communication server function unit transmits to the facility side communication agent function unit a new control command as a reply to the instant control result by taking an opportunity of receiving the instant control result as a request; and the facility side communication agent function unit receives from the server side communication server function unit using the facility side data communication unit the new control command as a reply, instantly controls the facility apparatus in accordance to the new control command received, and transmits the instant control result as a request to the server side communication server function unit using the facility side data communication unit,
wherein the server side communication server function unit, when ending the remote control of the facility apparatus, after receiving a last instant control result being a last request, transmits to the facility side communication agent function unit an end command instructing an end of the control to the facility apparatus as a reply to the last instant control result;
wherein the facility side communication agent function unit receives using the facility side data communication unit the end command as a reply, and stops transmission of the request to the server side communication server function unit when the end command is received.

4. The remote control system according to claim 1, further comprising a terminal apparatus that transmits the control command as a request to the server apparatus via the second network;
wherein the server side communication server function unit receives the control command as a request from the terminal apparatus via the second network;
wherein the server side outgoing call control unit transmits an outgoing call to the facility side control apparatus by taking an opportunity of receiving the control command from the terminal apparatus by the server side communication server function unit; and
wherein the server side communication server function unit transmits to the facility side communication agent function unit the control command received from the terminal apparatus as a reply to the control command request received from the facility side communication agent function unit.

5. The remote control system according to claim 4, wherein the facility side communication agent function unit instantly controls the facility apparatus in accordance with the control command received, and transmits the instant control result as a request, to the server side communication server function unit via the second network using the facility side data communication unit; and
wherein the server side communication server function unit receives from the facility side communication agent function unit the instant control result as a request via the second network, and transmits to the terminal apparatus the instant control result received as a reply to the request received from the terminal apparatus via the second network.

6. The remote control system according to claim 5 comprising the terminal apparatus, the server side communication server function unit, and the facility side communication agent function unit, for which the following operations are repeated once and more as one set: the terminal apparatus transmits to the server side communication server function unit via the second network a new control command as a request by taking the opportunity of receiving the instant control result as a reply; the server side communication server function unit receives from the terminal apparatus via the second network the new control command, and transmits to the facility side communication agent function unit as a reply to the instant control result serving as a request received from the facility side communication agent function unit the new control command received; the facility side communication agent function unit receives from the server side communication server function unit using the facility side data communication unit the new control command as a reply, instantly controls the facility apparatus in accordance with the new control command received, and transmits to the server side communication server function unit using the facility side data communication unit an instant control result as a request; and the server side communication server function unit receives the instant control result as a request from the facility side communication agent function unit, and transmits to the terminal apparatus as a reply to the new control command serving as the request received from the terminal apparatus the instant control result received;
wherein the terminal apparatus, when ending the remote control of the facility apparatus, after receiving from the server side communication server function unit a last instant control result serving as a last reply, transmits to the server side communication server function unit via the second network an end command that instructs an end of the control to the facility side control apparatus as a request;
wherein the server side communication server function unit receives the end command as a request, and transmits the end command received to the facility side communication agent function unit as a reply to the instant control result serving as a request received last from the facility side communication agent function unit; and
wherein the facility side communication agent function unit receives using the facility side data communication unit the end command transmitted as a reply by the server side communication server function unit, and stops transmission of the request to the server side communication server function unit when the end command is received.

7. The remote control system according to claim 3, wherein the facility side communication agent function unit disconnects a communication with the server side communication server function unit using the facility side data communication unit in case a predetermined time has elapsed without receiving from the server side communication server function unit the new control command as a reply to the instant control result, after transmitting the instant control result as a request using the facility side data communication unit.

8. The remote control system according to claim 1,
wherein the server side outgoing call function unit includes to the outgoing call an identification number that identifies a call origin being the server apparatus; and
wherein the facility side communication agent function unit transmits to the server side communication server function unit the control command request only when the identification number included to the outgoing call is an identification number of the server apparatus.

9. The remote control system according to claim 1 comprising the server side communication server function unit and the facility side communication agent function unit, in which an HTTP (hyper text transfer protocol) protocol is used for a communication via the second network.

10. The remote control system according to claim 4 comprising the server side communication server function unit, the facility side communication agent function unit, and the terminal apparatus, in which an HTTP (hyper text transfer protocol) protocol is used for a communication via the second network.

11. The remote control system according to claim 10, wherein the terminal apparatus uses a WWW (World Wide Web) browser, for a communication with the server side communication server function unit.

12. The remote control system according to claim 1, wherein the first network includes a public line.

13. The remote control system according to claim 1, wherein the first network is an IP (internet protocol) telephone network.

14. The remote control system according to claim 1, wherein the facility side incoming call receiving unit is implemented by any one of cellular phone or PHS™ (personal handy-phone system) terminal.

15. The remote control system according to claim 1, wherein the second network includes a packet network.

16. The remote control system according to claim 1, wherein the second network includes a data communication network.

17. A facility side control apparatus for receiving a control command that instructs a control of a facility apparatus via a network, and executing an instant control of the facility apparatus in accordance with the control command received, comprising:
a facility side incoming call receiving unit that receives, from a server apparatus for receiving a control command request requesting for the control command as a request via a second network while transmitting an outgoing call via a first network and for replying via the second network the control command as a reply to the control command request received, via the first network the outgoing call transmitted by the server apparatus;
a facility side incoming call controlling unit that detects the outgoing call received by the facility side incoming call receiving unit as an incoming call;
a facility side data communication unit that can communicate with the server apparatus via the second network by connecting to the second network; and
a facility side communication agent function unit that transmits to the server apparatus via the second network the control command request as a request using the facility side data communication unit when the facility side incoming call controlling unit detects the incoming call, that receives from the server apparatus via the second network using the facility side data communication unit the control command as a reply to the control command request, and that instantly controls the facility apparatus in accordance with the control command received.

18. A control program of a facility apparatus performed by a facility side control apparatus, being a computer, for receiving via a network a control command that instructs a control of the facility apparatus, and executing an instant control of the facility apparatus in accordance with the control command received, comprising:
(1) a process of receiving, from a server apparatus for receiving a control command request requesting for the control command as a request via a second network while transmitting an outgoing call via a first network and for replying via the second network the control command as a reply to the control command request received, via the first network the outgoing call transmitted by the server apparatus;
(2) a process of detecting the outgoing call received as an incoming call; and
(3) a process of transmitting to the server apparatus via the second network the control command request as a request by taking an opportunity of incoming call detection, receiving from the server apparatus via the second network the control command as a reply to the control command request, and instantly controlling the facility apparatus in accordance with the control command received.

19. A control method of a facility apparatus performed by a facility side control apparatus, for receiving via a network a control command that instructs a control of the facility apparatus, and executing an instant control of the facility apparatus in accordance with the control command received, comprising:
receiving, from a server apparatus for receiving a control command request requesting for the control command as a request via a second network while transmitting an outgoing call via a first network and for replying via the second network the control command as a reply to the control command request received, via the first network the outgoing call transmitted by the server apparatus, by a facility side incoming call receiving unit;
detecting the outgoing call received by the facility side incoming call receiving unit as an incoming call, by a facility side incoming call controlling unit; and
transmitting to the server apparatus via the second network the control command request as a request by taking an opportunity of incoming call detection by the facility side incoming call controlling unit, receiving from the server apparatus via the second network the control command as a reply to the control command request, and instantly controlling the facility apparatus in accordance with the control command received, by a facility side communication agent function unit.
